(19) United States
(12) Patent Application Publication
(10) Pub. No.: US 2016/0036537 A1
(43) Pub. Date: Feb. 4, 2016

(54) ELECTRONIC DEVICE TESTING SYSTEM

(71) Applicant: HON HAI PRECISION INDUSTRY CO., LTD., New Taipei (TW)

(72) Inventor: PO-HSIEN LIU, New Taipei (TW)

(21) Appl. No.: 14/573,087

(22) Filed: Dec. 17, 2014

(30) Foreign Application Priority Data
Aug. 1, 2014 (TW) 103126367

(51) Int. Cl. H04B 17/16; H04B 5/00; H04W 4/00

(52) U.S. Cl. CPC H04B 17/16; H04W 4/008; H04B 5/00

(57) ABSTRACT

A detecting device is utilized for communicating a data processing client to an electronic device with a near field communication module. The detecting device includes a detecting module, a first processing module and a first near field communication module. The detecting device detects whether the electronic device is in a determined range and wirelessly communicating with the electronic device for testing.

### FIELD

The subject matter herein generally relates to electronic device testing systems.

### BACKGROUND

It is necessary to connect a many electrical wires to an electronic device for testing.

### BRIEF DESCRIPTION OF THE DRAWINGS

Implementations of the present technology will now be described, by way of example only, with reference to the attached figures.

FIG. 1 is a block diagram of an embodiment of a testing system.

FIG. 2 is a flow chart of the testing system of the present disclosure.

FIG. 3 is a flow chart of the testing system shown in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

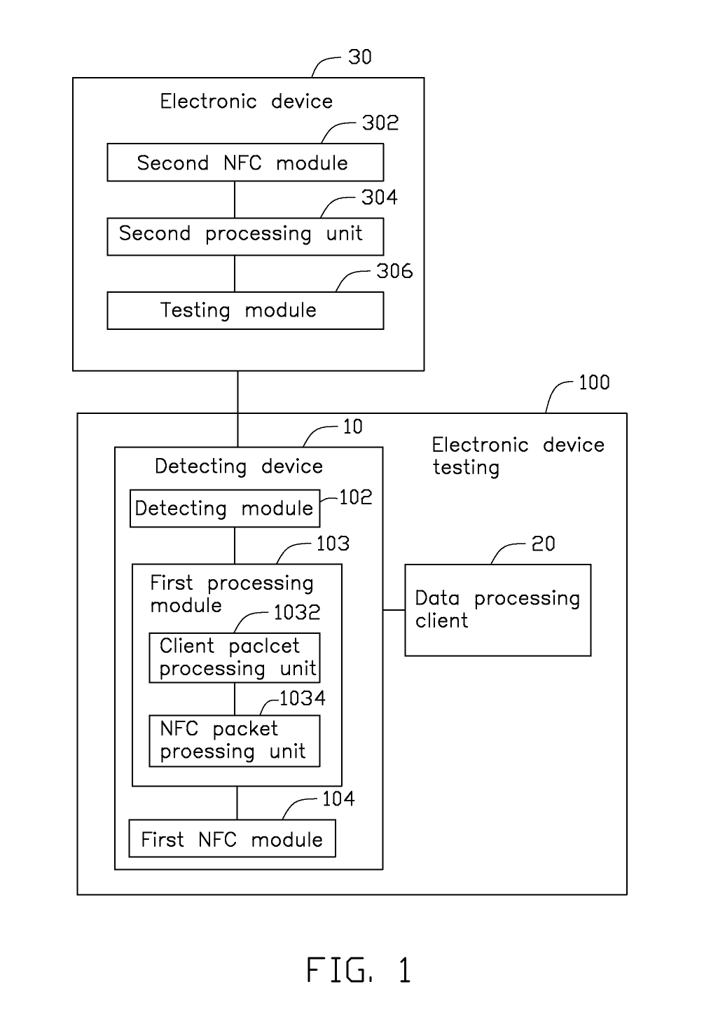

FIG. 1 illustrates an embodiment of an electronic device testing system 100 which can include a detecting device 10 and a data processing client 20. The data processing client 20 is electrically connected to the detecting device 10. The electronic device testing system 100 is configured for running function tests on the electronic device 30. When the detecting device 10 determines that the electronic device 30 is within a determined range, a trigger signal is transmitted to the data processing client 20. The data processing client 20 is triggered, and a test command signal is transmitted to the electronic device 30 via the detecting device 10. The electronic device 30 runs function tests according to the test command signal and outputs a test result to the data processing client 20 via the detecting device 10. The electronic device 30 is determined as “PASS” or “FAIL” according to the test result by the data processing client 20.

In the present disclosure, the detecting is embedded in a work station, which includes a body (not shown), a detecting module 102, a first processing module 103 and a first near field communication (NFC) module 104. The detecting module 102 is electrically connected to the first processing module 103. The trigger signal is transmitted to the first processing module 103 by the detecting module 102. The trigger signal is transformed to a trigger signal packet by the first processing module 103. The trigger signal packet is transmitted to the data processing client 20. Then a test command packet is generated and transmitted from the data processing client 20. The first NFC module 104 is electrically connected to the first processing module 103. The first NFC module 104 is configured for wireless communication with the electronic device 30.

The first processing module 103 further includes a client packet processing unit 1032 and a NFC packet processing unit 1034. The client packet processing unit 1032 is electrically connected to the NFC packet processing unit 1034. The NFC packet processing unit 1034 is configured for transforming the test command signal to a test command packet. The test command packet is transmitted from the NFC packet processing unit 1034 to the first NFC module 104.

The NFC module 104 is configured for transmitting the test command NFC packet to the electronic device 30.

The electronic device 30 can be a computer, a mobile phone or a personal digital assistant. The electronic device 30 includes a second NFC module 302, a second processing module 304 and a testing module 306. The second NFC module 302 is configured for communicating with the detecting device 10 and receiving the test command NFC packet from the first NFC module 104 of the detecting device 10. The second NFC module 302 is configured for transmitting the test command NFC packet to the second processing module 304. The test command NFC packet is transformed to a test command NFC signal. The test command NFC signal is transmitted to the testing module 306. The testing module 306 is tested according to the test command NFC signal and a test result signal is generated. The test result is transmitted to the second processing module 304. The test result signal is transformed to test result NFC packet and transmitted to the second NFC module 302. The second NFC module 302 is configured for transmitting the NFC packet to the first NFC module 104 of the electronic device 30 via NFC communication.

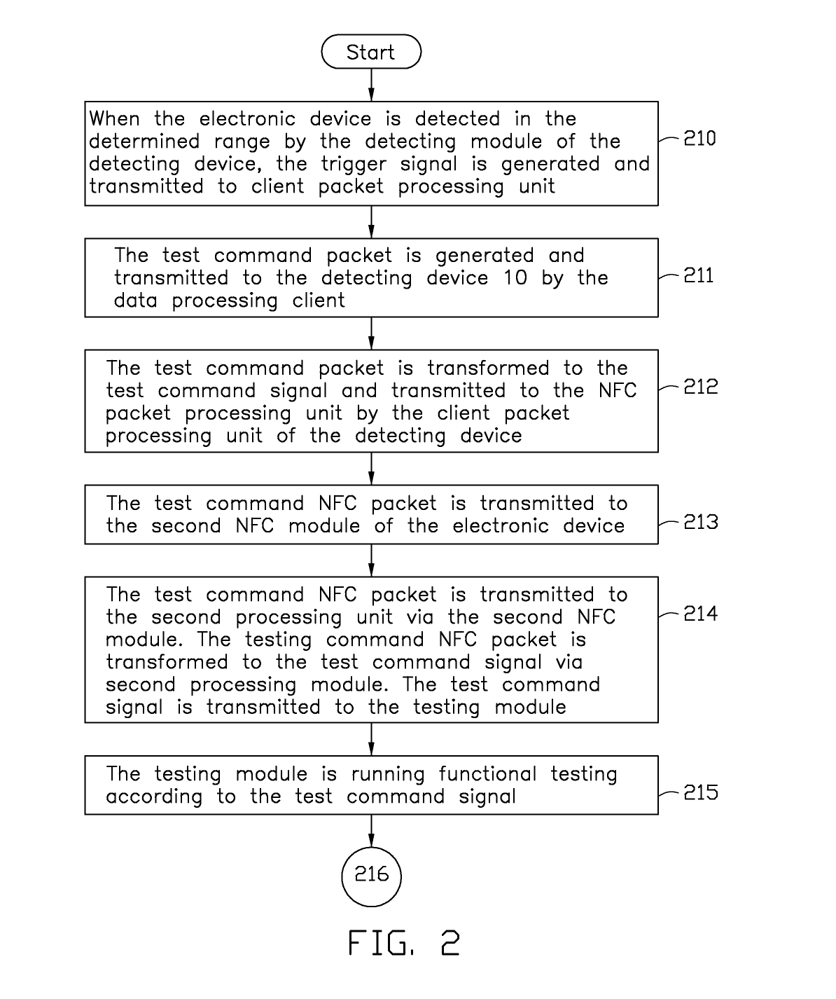

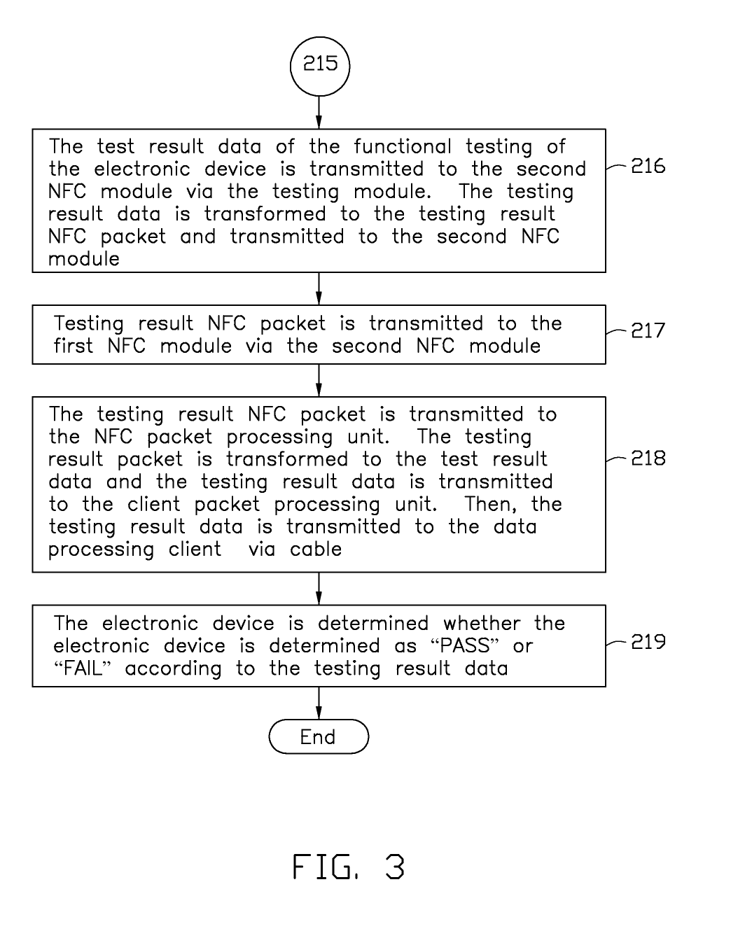

Referring to FIGS. 2 and 3, a flowchart is presented in accordance with an example embodiment. The example testing system 100 is provided by way of example, as there are a variety of ways to carry out the method. The testing system 100 described below can be carried out using the configurations illustrated in FIGS. 1, for example, and various elements of these figures are referenced in explaining example testing system 100. Each block shown in FIGS. 2 and 3 represents one or more processes, methods or subroutines, carried out in the example testing system 100. Furthermore, the illustrated order of blocks is illustrative only and the order of the blocks can change according to the present disclosure. Additional blocks can be added or fewer blocks may be utilized, without departing from this disclosure. The example testing system 100 can begin at block 210. Illustrates in block 210, when the electronic device 30 is detected in the determined range by the detecting module 102 of the detecting device 10, the trigger signal is generated and transmitted to the client packet processing unit 1032. The trigger signal is transformed to the trigger signal packet by the client packet processing unit 1032 and the transmitted to the data processing client 20.

In the block 211, the test command packet is generated and transmitted to the detecting device 10 by the data processing client 20.

In block 212, the test command packet is transformed to the test command signal and transmitted to the NFC packet processing unit 1034 by the client packet processing unit 1032 of the detecting device 10. The test command signal is transformed to the test command NFC packet by the near field communication (NFC) packet processing unit 1034. The test command NFC packet is transmitted to the first NFC module 104.

In block 213, the test command NFC packet is transmitted to the second NFC module 302 of the electronic device 30 via the first NFC module 301.

In block 214, the test command NFC packet is transmitted to the second processing unit 304 via the second NFC module 302 of the electronic device 30. The test command NFC packet is transformed to the test command signal via second processing module 304. The test command signal is transmitted to the testing module 306 via the second processing module 304.

In block 215, the testing module 306 is running function testing according to the test command signal.

In block 216 (shown in FIG. 3), the test result data of the function testing of the electronic device 30 is transmitted to the second NFC module 302 via the testing module 306. The testing result data is transformed to the testing result NFC packet and transmitted to the second NFC module 302.

In block 217, testing result NFC packet is transmitted to the first NFC module 104 via the second NFC module 302.

In block 218, the testing result NFC packet is transmitted to the NFC packet processing unit 1034 via the NFC module 104. The testing result packet is transformed to the test result data by the NFC packet processing unit 1034. The testing result data is transmitted to the client packet processing unit 1032. Then, the testing result data is transmitted to the data processing client 20 via cable.

In block 219, the electronic device 30 is determined as “PASS” or “FAIL” according to the testing result data. If the electronic device 30 is determined as “PASS”, the electronic device 30 is transported to next work station of the assembly line. If the electronic device 30 is determined “FAIL”, the electronic device 30 is transported to an analyzing station.

The embodiments shown and described above are only examples. Many details are often found in the art such as the other features of an electronic device testing system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A detecting device that detects communications between a data processing client and an electronic device with a near field communication module, the detecting device comprising:
a detecting module;
a first processing module; and
a first near field communication module;
wherein the detecting module and the first near field communication module being electrically connected to the first processing module, the first near field communication module wirelessly communicates with the near filed communication module of the electronic device, the first processing device being electrically connected to the data processing client, the detecting module being configured to detect the electronic device and generate a trigger signal, the trigger signal being transformed to a trigger signal packet by the first processing module, the trigger signal packet being transmitted to the data processing client, a test command signal packet being transmitted to the first processing module by the data processing client, the test command packet being transformed to the test command near field communication package when the test command packet is received by the first processing module, the test command near field communication packet being transmitted to the electronic device via the first near field communication module, the electronic device runs functional testing and transmits the test result near field communication packet to the first processing module, the test result near field communication packet is transformed to a test result packet by the first processing module, the testing result signal packet being transmitted to the data processing client.

2. The detecting device of claim 1, wherein the first processing module comprising a client packet processing unit and a near field communication packet processing unit, the client packet processing unit is electrically connected to the near field communication packet processing unit, the client packet processing unit is electrically connected to the data processing module, the near field communication packet processing unit is electrically connected to the first near field communication module, the client packet is transformed to digital signals by the client packet processing unit, the test command signal is transmitted to the near field communication packet processing unit via the client packet processing unit, the digital signals are transformed to a near field communication packet via the near field communication packet processing unit, the near field communication packet is transmitted to the first near field communication module.

3. A testing system for an electronic device, comprising:
a data processing client;
a detecting device comprising a detecting module, a first processing module and a first near field communication module;
wherein the detecting module and the first near field communication module being electrically connected to the first processing module; the first near field communication module wirelessly communicates with the near filed communication module of the electronic device, the first processing device is electrically connected to the data processing client, the detecting module is configured to detect the electronic device and generate a trigger signal, the trigger signal is transformed to a trigger signal packet by the first processing module, the trigger signal packet is transmitted to the data processing client, a test command signal packet is transmitted to the first processing module by the data processing client, the test command packet is transformed to the test command near field communication package when the test command packet is received by the first processing module, the test command near field communication packet is transmitted to the electronic device via the first near field communication module, the electronic device runs a functional test and transmits the test result near field communication packet to the first processing module, the test result near field communication packet is transformed to a test result packet by the first processing module, the testing result signal packet is transmitted to the data processing client.

4. The testing system of claim 3, wherein the first processing module comprises a client packet processing unit and a near field communication packet processing unit, the client packet processing unit is electrically connected to the near field communication packet processing unit, the client packet processing unit is electrically connected to the data processing module, the near field communication packet processing unit is electrically connected to the first near field communication module, the test command signal is transmitted to the near field communication packet processing unit via the client packet processing unit, the test command signal is transformed to a test command near field communication packet by the near field communication packet processing unit, the test command near field communication packet is transmitted to the first near field communication module via the near field communication packet processing unit.
